(19) United States
(12) Patent Application Publication
(10) Pub. No.: US 2014/0175241 A1
(43) Pub. Date: Jun. 26, 2014

(54) GUITAR HOLDING RACK WITH AN ADJUSTABLE INTERVAL

(71) Applicant: RELLIANCE INTERNATAIONAL CORP., Taipei City (TW)

(72) Inventor: BEAN YANG, Taipei City (TW)

(73) Assignee: RELIANCE INTERNATIONAL CORP., Taipei City (TW)

(21) Appl. No.: 13/724,260

(22) Filed: Dec. 21, 2012

(51) Int. Cl. G10G 5/00

(52) U.S. Cl. CPC G10G 5/00
USPC 248/274.1

(57) ABSTRACT

A guitar holding rack with an adjustable interval comprises a first brace arm, a second brace arm corresponding to the first brace arm and an interval adjustment unit hinged between the two brace arms. The first and second brace arms have respectively a holding sections spaced from each other to form a holding space to hold the neck of a guitar and to be leaned by the guitar, and an extension section connected to the holding section and spaced from each other by an adjustment gap. The interval adjustment unit is hinged in the adjustment gap and bridges the two extension sections, and also has a first adjustment displacement in which the two holding sections are driven by extension sections inwards toward the holding space and a second adjustment displacement in which the two holding sections are driven by the extension sections outwards from the holding space.

### FIELD OF THE INVENTION

The present invention relates to a guitar holding rack and particularly to a guitar holding rack contained an adjustable holding space formed between a first brace arm and a second brace arm to hold guitars of varying specifications.

### BACKGROUND OF THE INVENTION

In general after a musical performance is finished musicians usually rest the musical instruments temporarily by leaning them on a wall in an inclined manner to wait for the next round of performance. The resting wall generally is a makeshift location without a secure holding structure to firmly hold the musical instruments. Hence the musical instruments are prone to fall down incidentally and damage. To solve this problem holding racks to hold musical instruments have been developed and marketed. For guitar holding racks, many proposals have been submitted in the past, such as R.O.C. patent Nos. 486132, M274611 and 1300550, China patent Nos. CN201084394 and CN201199432, and International intellectual right organization gazette No. WO2011137666. They mostly have an upper rack to hold the neck of a guitar and a lower rack to hold the guitar body. The upper rack usually has a first brace arm and a second brace arm to form a holding space between them to hold the guitar. The holding space usually is designed according to the width of the neck of the guitar to fully hold the neck without falling incidentally. At present the upper rack mainly has a retaining portion which can be opened and closed synchronously or independently. For instance, the references of M274611, 1300550 and 486132 mentioned above adopt an upper rack which can be opened and closed synchronously, while CN201084394 adopts an upper rack which can be opened and closed independently. Whether the upper rack is opened and closed synchronously or independently, it is fixed after production. To hold guitars of different specifications another size of guitar holding rack has to be procured. In other words, the conventional guitar holding racks now being commonly used are not adaptable to different specifications of guitars. Whenever users have procured a new type of guitar, another guitar holding rack also has to be procured.

### SUMMARY OF THE INVENTION

The primary object of the present invention is to provide a guitar holding rack with an adjustable holding space interval.

To achieve the foregoing object the guitar holding rack with an adjustable interval according to the invention comprises a first brace arm, a second brace arm corresponding to the first brace arm and an interval adjustment unit hinged between the first and second brace arms. The first and second brace arms have respectively a holding section spaced from each other by a holding space to hold the neck of a guitar and to be leaned thereon, and an extension section connected to the holding section and spaced from each other by an adjustment gap. The interval adjustment unit is hinged in the adjustment gap and bridges the extension sections of the first and second brace arms, and has a first adjustment displacement in which the two extension sections are driven to move the two holding sections inwards toward the holding space, and a second adjustment displacement in which the two extension sections are driven to move the two holding sections outwards from the holding space.

In one embodiment the holding sections of the first and second brace arms have respectively at least one elastic buffer in contact with the neck of the guitar.

In another embodiment the first and second brace arms have respectively a retaining member at one end thereof opposite to the extension section to prevent the guitar from escaping the holding space.

In yet another embodiment the guitar holding rack further has a bridge portion connected to the first brace arm and second brace arm. The bridge portion includes a pivotal coupling portion connected to the extension sections and a holding trough to hold the extension sections of the first and second brace arms. Furthermore, the bridge portion has a fastening portion to couple on an upright support post.

In yet another embodiment the guitar holding rack further includes an upper lid and a lower lid corresponding to the upper lid that can be coupled together to form a housing space to hold the extension sections of the first and second brace arms and the interval adjustment unit.

In yet another embodiment the interval adjustment unit includes a first butting portion extended from the extension section of the first brace arm and a second butting portion extended from the extension section of the second brace arm. The extension sections have respectively a fastening hole to hinge the first and second butting portions. Furthermore, the first and second butting portions have respectively a corresponding screw thread structure mating the fastening hole. The interval adjustment unit also includes an operating portion operable by users to drive the first and second butting portions to make the interval adjustment unit to proceed the first adjustment displacement or second adjustment displacement.

By means of the structure set forth above, compared with the conventional guitar holding racks, the invention provides many features, notably:

It can hold guitars of more specifications. The guitar holding rack of the invention, through the interval adjustment unit proceeding the first adjustment displacement or second adjustment displacement, can move the holding sections of the first brace arm and second brace arm to change the size of the holding space, thereby can hold the guitars of varying specifications.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the guitar holding rack with an adjustable interval of the invention.

FIG. 2 is an exploded view of an embodiment of the invention.

FIG. 3 is a schematic view of an embodiment of the invention for holding a guitar.

FIG. 4 is a schematic view of an embodiment of the invention in an adjustment displacement operation.

FIG. 5 is a schematic view of an embodiment of the invention in another adjustment displacement operation.

### DETAILED DESCRIPTION OF THE PREFERRED EMBODIMENTS

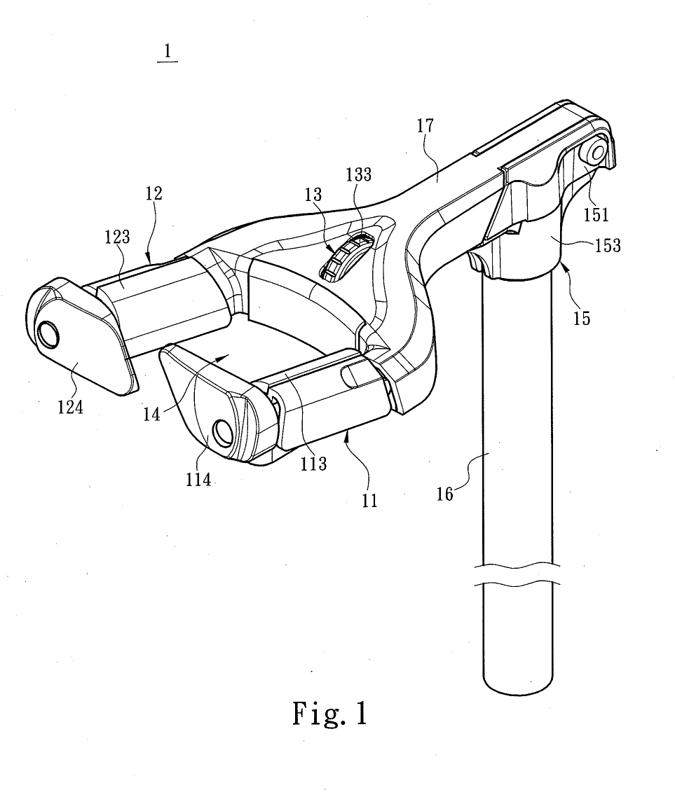

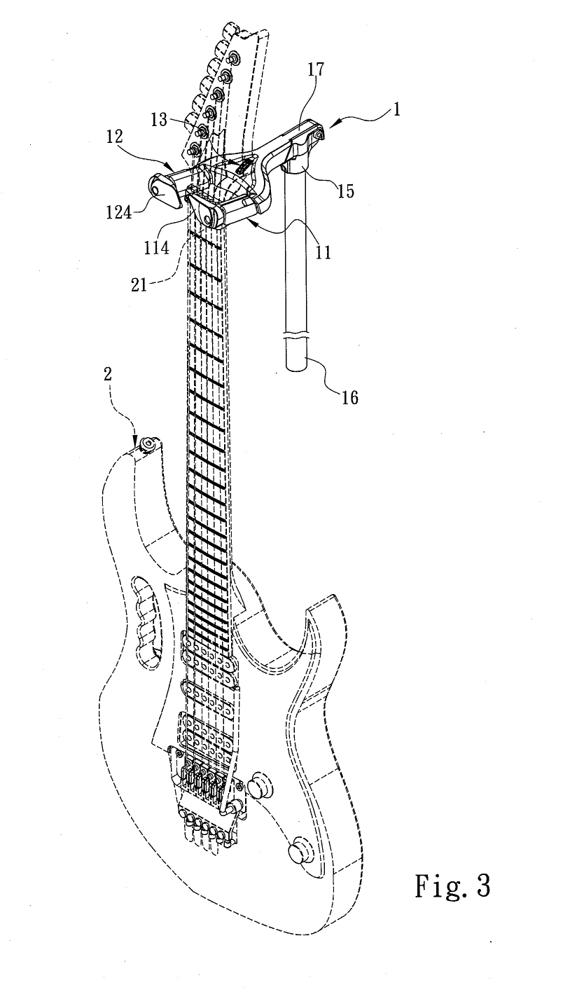

Please referring to FIGS. 1 through 4, the present invention aims to provide a guitar holding rack 1 with an adjustable interval to hold guitars 2 of different specifications. The guitar holding rack 1 comprises a first brace arm 11, a second brace arm 12 corresponding to the first brace arm 11 and an interval adjustment unit 13 hinged between the first and second brace arms 11 and 12. The first brace arm 11 and second brace arm 12 are structured corresponding to each other, and include respectively a holding section 111 and 121 spaced from each other by a holding space 14, and an extension section 112 and 122 connected to the holding sections 111 and 121 and spaced from each other by an adjustment gap D1. The holding space 14 can hold the neck 21 of a guitar 2 and allow the guitar 2 to lean inside. The interval adjustment unit 13 is hinged in the adjustment gap D1 between the two extension sections 112 and 122, and bridge and drive the extension sections 112 and 122 to move inwards toward the holding space 14 in a first adjustment displacement and outwards from the holding space 14 in a second adjustment displacement.

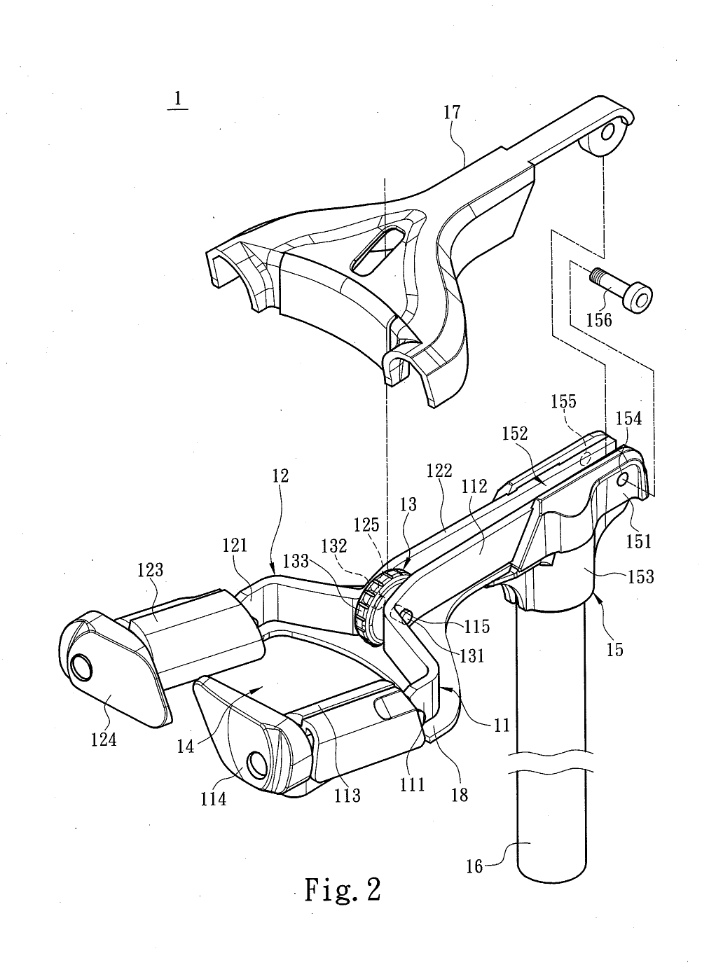

Please also referring to FIG. 2, furthermore, the holding sections 111 and 121 have respectively an elastic buffer 113 and 123 located thereon that can be made from elastic material such as sponge in contact with at least the neck 21 of the guitar, thereby can avoid damage of the neck 21 that might be caused by compact holding of the neck 21 resulting from the first brace arm 11 and second brace arm 12 in the holding space 14. The first and second brace arms 11 and 12 further have respectively a retaining member 114 and 124 at one end thereof opposite to the extension sections 112 and 122. The retaining members 114 and 124 can be opened and closed relative to each other so that the guitar 2 can be disposed into the holding space 14 in the open state and be prevented from escaping the holding space 14 in the closed state. The guitar holding rack 1 further can have a bridge portion 15 to bridge the first and second brace arms 11 and 12. The bridge portion 15 includes a pivotal coupling portion 151 hinged on the extension sections 112 and 122 and a holding trough 152 to hold the extension sections 112 and 122. Thereby, positioning of the extension sections 112 and 122 in the holding trough 152 can be adjusted as required. More specifically, the pivotal coupling portion 151 has apertures 154 and 155 at two ends of the holding trough 152 and a coupling member 156 to run through the two apertures 154 and 155. Furthermore, the first and second brace arms 11 and 12 also have respectively a coupling hole (not shown in the drawings) corresponding to the apertures 154 and 155. When the first and second brace arms 11 and 12 are held in the holding trough 152, the coupling holes and apertures 154 and 155 are aligned with each other, then the pivotal coupling member 156 runs through the two apertures 154 and 155 and coupling holes to form pivotal coupling. The positioning of the pivotal coupling member 156 mentioned above merely serves as an example and is not the limitation of the invention. Furthermore, the bridge portion 15 has a fastening portion 153 which can be coupled with an upright support post 16. The guitar holding rack 1 also includes an upper lid 17 and a lower lid 18 that correspond to each other and can be coupled together to form a housing space to hold the extension sections 112 and 122 and the interval adjustment unit 13 to form a completed assembly as shown in FIG. 1.

In addition, the interval adjustment unit 13 further has a first butting portion 131 extended against the extension section 112 of the first brace arm 11 and a second butting portion 132 extended against the extension section 122 of the second brace arm 12, and the extension sections 112 and 122 have fastening holes 115 and 125 hinged respectively by the first and second butting portions 131 and 132. During the first adjustment displacement the first and second butting portions 131 and 132 drive the extension sections 112 and 122 inwards toward the holding space 14, and during the second adjustment displacement the first and second butting portions 131 and 132 drive the extension sections 112 and 122 outwards from the holding space 14, thereby change the adjustment gap D1 and also change the holding space 14. Moreover, the first and second butting portions 131 and 132 have respectively a screw thread structure mating the fastening holes 115 and 125. The interval adjustment unit 13 also has an operating portion 133 operable by users to drive the first and second butting portions 131 and 132 to make the interval adjustment unit 13 to proceed the first or second adjustment displacement. The operating portion 133 can be formed in many styles.

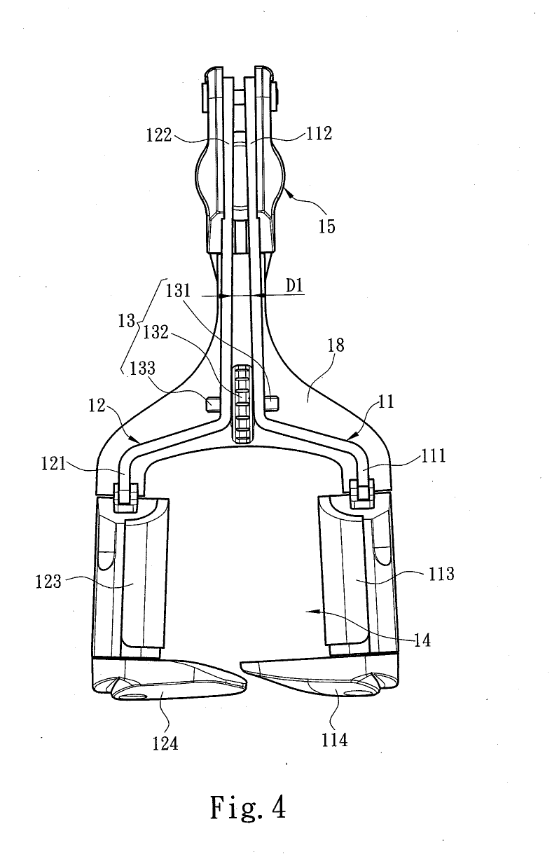

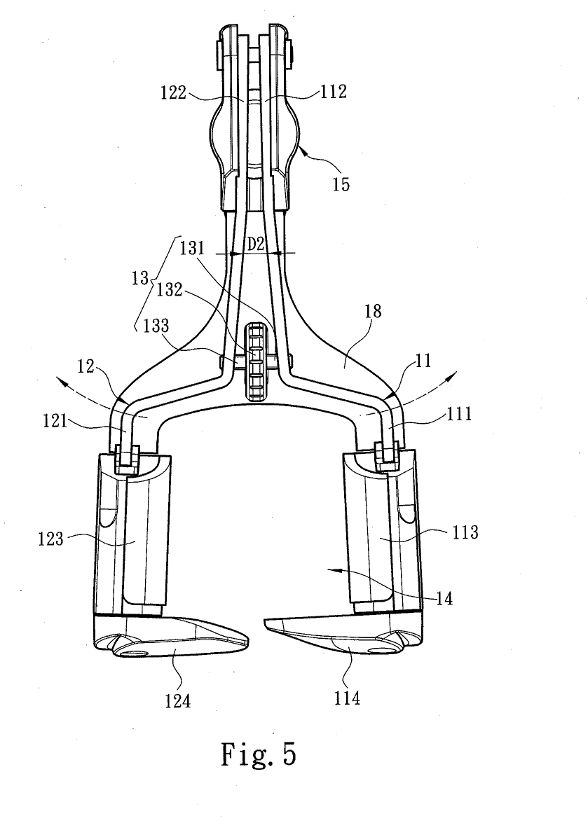

Please refer to FIGS. 4 and 5 for the guitar holding rack 1 in various conditions of the first and second adjustment displacements. At the initial state, referring to FIG. 4, the extension sections 112 and 122 of the first and second brace arms 11 and 12 are close to two sides of the interval adjustment unit 13, and the interval of the holding space 14 is minimum. When the interval adjustment unit 13 is maneuvered by a user to perform the second adjustment displacement, by turning in one direction as an example, the interval adjustment unit 13 drives the extension sections 112 and 122 to gradually increase the adjustment gap D2 between the first and second brace arms 11 and 12, and also move the holding sections 111 and 121 outwards from the holding space 14 so that the holding space 14 also becomes winder; when a required interval is reached, operation on the interval adjustment unit 13 can be stopped. In the invention the first adjustment displacement is a reverse process of the second adjustment displacement. Hence the interval adjustment unit 13 can be turned in another direction opposite to that of the second adjustment displacement so that the first and second brace arms 11 and 12 also can be driven inwards toward the holding space 14 to shrink the holding space 14 gradually. Thus the user can maneuver the interval adjustment unit 13 as desired to perform the first or second adjustment displacement, and change the holding space 14 according to the neck 21 of the guitar to be held and leaned.

As a conclusion, the guitar holding rack with an adjustable interval of the invention provides the interval adjustment unit to perform the first or second adjustment displacement, and drive the extension sections of the first and second brace arms towards or from the holding space, thereby change the interval of the holding space to fit not merely a singe guitar, but also can hold other guitars of different specifications.

While the preferred embodiments of the invention have been set forth for the purpose of disclosure, they are not the limitation of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A guitar holding rack providing an adjustable interval, comprising:
a first brace arm and a second brace arm corresponding to each other and including respectively a holding section spaced from each other to form a holding space to hold the neck of a guitar and receive the guitar, and an extension section connected to the holding section and spaced from each other by an adjustment gap; and
an interval adjustment unit which is hinged in the adjustment gap and connected to the extension sections, and includes a first adjustment displacement to drive the two extension sections and move the two holding sections inwards toward the holding space and a second adjustment displacement to drive the two extension sections and move the two holding sections outwards from the holding space.

2. The guitar holding rack of claim 1, wherein the holding sections include respectively at least one elastic buffer in contact with the neck of the guitar.

3. The guitar holding rack of claim 1, wherein the first brace arm and the second brace arm include respectively a retaining member at one end thereof opposite to the extension section to prevent the guitar from escaping the holding space.

4. The guitar holding rack of claim 1 further including a bridge portion to bridge the first brace arm and the second brace arm, the bridge portion including a pivotal coupling portion hinged on the two extension sections and a holding trough to hold the two extension sections.

5. The guitar holding rack of claim 4, wherein the bridge portion includes a fastening portion to couple on an upright support post.

6. The guitar holding rack of claim 1 further including an upper lid and a lower lid corresponding to each other to be coupled together to form a housing space to hold the extension sections and the interval adjustment unit.

7. The guitar holding rack of claim 1, wherein the interval adjustment unit includes a first butting portion extended against the extension section of the first brace arm and a second butting portion extended against the extension section of the second brace arm, each extension section containing a fastening hole hinged by the first butting portion and the second butting portion.

8. The guitar holding rack of claim 7, wherein the first butting portion and the second butting portion include respectively a screw thread structure mating the fastening hole.

9. The guitar holding rack of claim 7, wherein the interval adjustment unit includes an operating portion operable by a user to drive the first butting portion and the second butting portion and make the interval adjustment unit to proceed the first adjustment displacement or the second adjustment displacement.
